(19) United States
(12) Patent Application Publication
(10) Pub. No.: US 2015/0335520 A1
(43) Pub. Date: Nov. 26, 2015

(54) VIBRATOR

(71) Applicant: AMOR Gummiwaren GmbH, Arnstadt (DE)

(72) Inventor: Michael Dills, Arnstadt (DE)

(73) Assignee: AMOR Gummiwaren GmbH, Arnstadt (DE)

(21) Appl. No.: 14/410,323

(22) PCT Filed: Jun. 6, 2013
(86) PCT No.: PCT/EP2013/061642

§ 371 Date: Dec. 22, 2014

(30) Foreign Application Priority Data
Jun. 22, 2012 (DE) 10 2012 105 466.5

(51) Int. Cl. A61H 23/02; A61H 19/00

(52) U.S. Cl. CPC A61H 23/02; A61H 19/30

(57) ABSTRACT

A vibrator (1) with a vibrator component (3) and an operating component (5) connected to the vibrator component (3) is provided, wherein the vibrator (1) comprises an electric motor (7) serving to generate vibrations, an energy storage unit, and a control unit (13), and wherein the operating component (5) comprises a housing (17) and at least one operating element (15, 16). The vibrator (1) is characterized in that the vibrator (1) also comprises a wireless data communications device (20) connected to the control unit (13), and in that a camera element (19) is integrated into the operating component (5), which camera is connected to the wireless data communications device, wherein the wireless data communications device (20) is configured to transmit data from the camera element (19) to a remote display device.

The present invention pertains to a vibrator according to the preamble of claim 1.

Vibrators are erotic toys which serve to provide a user with sexual stimulation, massage or medical applications. For this purpose, the vibrator generates vibrations or, in general, oscillations and/or movements, which are usually produced by an electric motor with an unbalanced mass. To produce the stimulation of the person using the vibrator, the vibrator is brought into contact with especially sensitive body parts such as the external or internal sex organs. The vibrator is thus placed on these body parts or introduced into them, for example, vaginally. As a result of the vibrations generated by the vibrator, the body parts in question are stimulated.

Such vibrators are known from, for example, DE 20 2009 008 634 U1 and DE 20 2009 007 125 U1.

The erotic industry earns most of its sales today on the Internet, especially through the provision of photos and videos against payment. To an increasing extent, merchants are relying on interactions between the client and the service provider through communication over webcams or smartphones with the help of the corresponding application programs (apps), wherein the client receives real-time video and audio signals from a service provider over the Internet. By making use of further development of the technical possibilities, the industry is searching for new possibilities of communication and interaction between client and service provider via the Internet as medium. In doing so, the use of a vibrator by the service provider is a popular variant.

US 2007/0055096 A1 discloses a vibrator with a control unit and a Bluetooth communications device, by means of which the vibrator is adapted to establish a connection with a Bluetooth device such as a telephone, a PC, or a television and to play audio/video data on or from this device.

DE 20 2010 013 764 U1 discloses a vibrator with a camera firmly mounted thereon. The single exemplary embodiment describes a bracket which can be plugged into the end of the vibrator; the camera is then mounted on the bracket.

It is therefore the object of the present invention to provide a vibrator which opens up new possibilities for data communications exchange and interaction between clients and their service providers and which makes it possible in particular for the client to observe the use of the vibrator and to control its functions in real time.

This object is achieved by the features of claim 1. Advantageous embodiments are described in the subclaims.

According to the invention, a vibrator with a vibrator component and an operating component connected to the vibrator component is provided, wherein the vibrator comprises an electric motor serving to generate vibrations, an energy storage unit, and a control unit, and wherein the operating component comprises a housing and at least one operating element, wherein the vibrator comprises a wireless data communications device connected to the control unit. It is characterized in that a camera element is integrated into the operating component, the camera being connected to the wireless data communications device, and in that the operating component comprises a protrusion projecting from the surface of the housing with a window for the camera element, which protrusion forms a liquid-tight, essentially seamless transition to the surface of the housing, wherein the wireless data communications device is configured to transmit the data generated by the camera element to a remote display unit. By means of the vibrator according to the invention, it is possible, during the use of the vibrator, to transmit images or videos, especially close-ups of the environment in which it is being used, wirelessly to one or more remote display units. The vibrator can thus be controlled for example, by means of a Bluetooth-capable smartphone running an application program (app).

By providing the protrusion the field of view of the camera element is enlarged, preferably in the direction toward the vibrator component. Thus, for example, it is possible to take close-up views of the external sex organs during the use of the vibrator.

The functions and also the programming of the vibrator are preferably remote-controlled by a remote control unit using the wireless data communications device. This has the technical effect that an observer not participating in the direct use of the vibrator can control its use. Especially in conjunction with the image supplied by the camera element, new, previously unknown opportunities for interaction are thus offered. The wireless data communication device also makes it possible to load certain program sequences of vibrator functions into the control unit of the vibrator from an external source, e.g., from an “app.”

It is especially advantageous for the at least one operating element to be configured as a rotary wheel integrated into the housing of the operating component. The rotary wheel controls, for example, the intensity of the vibrations and can also serve as an on-off switch. The rotary wheel integrated into the operating element has been found to be an especially low-cost and reliable variant of an operating element; it also functions reliably and is of simple design. In particular, it can also be operated reliably even in a state of reduced fine-motor control during a stimulation phase and has favorable haptic properties even under extreme conditions such as darkness or reduced surface adhesion caused by body fluids or liquid lubricants. The rotary wheel also advantageously forms a liquid-tight seal with the surface of the operating component.

It is also advantageous for the operating component to comprise two electrical charging contacts on the outside surface of the housing, these contacts being configured to be liquid-tight. The material of the charging contacts is preferably corrosion-proof steel. With these charging contacts, the vibrator can be easily electrically recharged in an appropriately configured charging device or charging cradle. Because the vibrator is leak-tight, it meets the high hygienic requirements on all external components of the vibrator.

It is also advantageous for the operating component to comprise at least one display area, which is adapted to display the functional state of the vibrator. The display area can be configured as a pressure-sensitive switching or operating element. As a result, it becomes especially easy to operate the vibrator, because simply pressing on the pressure-sensitive switch element changes the functional state of the vibrator and simultaneously displays that state by means of, for example, an appropriate form of illumination.

This illumination is advantageously realized in that the operating component comprises at least one light-emitting diode (LED). LEDs provide low-cost, energy-saving light sources, which can also be configured in a wide variety of colors. Thus client color preferences of almost any desired type can be realized, and they can be loaded from an external source as previously determined color sequences into the control unit of the vibrator, for example, by means of an app. It is also advantageous for the outer jacket of the vibrator to be translucent in the area of the LEDs; that is, the light of the LEDs can shine through the outer jacket, whereas the structural elements in the interior remain invisible from the outside.

It is especially advantageous for the wireless data communications device to be configured as a Bluetooth or WLAN/Wi-Fi module. These data transmission standards (e.g., Bluetooth 1.0-4.0 with Low Energy) provide sufficiently high data transmission rates, which are adapted to the transmission of photos or videos, possibly even in 3D, in addition to an audio signal. In particular, these standards are adapted to provide video data in PAL, NTSC, DV, or HDTV formats in real time, so that interactive use from a remote location is supported.

It has been found to be especially advantageous for the control unit and the wireless data communications device to be designed as a single, integrated component. As a result, a control unit with the simplest possible, most compact configuration is obtained. The control unit can comprise a data storage device, which can serve, for example, for the intermediate storage of program, image, and video data.

The invention is explained in greater detail below with reference to the exemplary embodiments shown in the drawings:

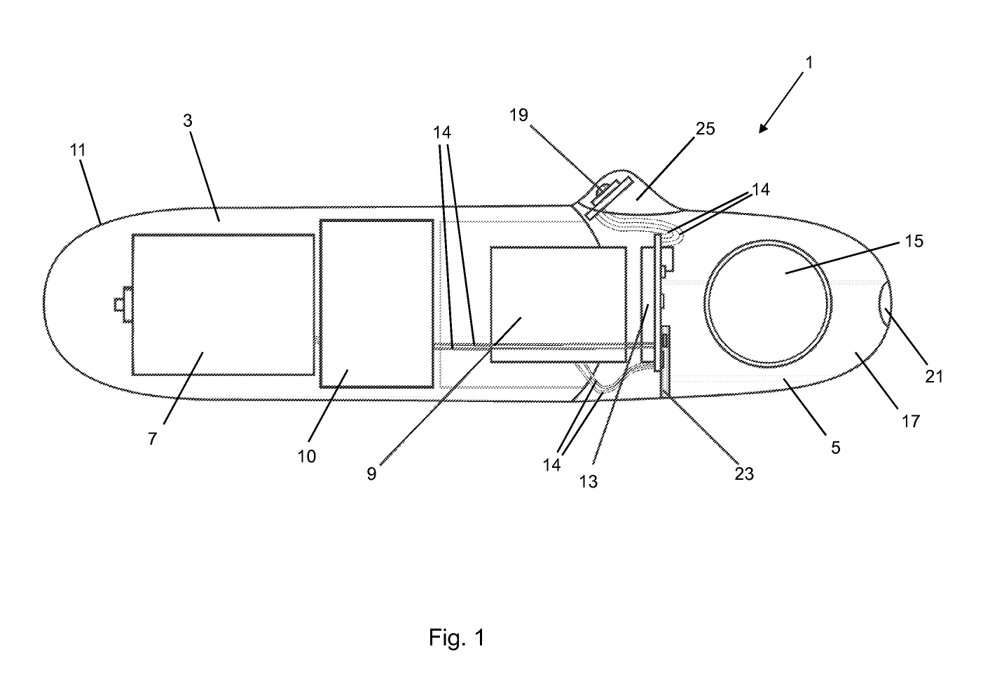

FIG. 1 shows a schematic diagram of a preferred embodiment of the vibrator according to the invention;

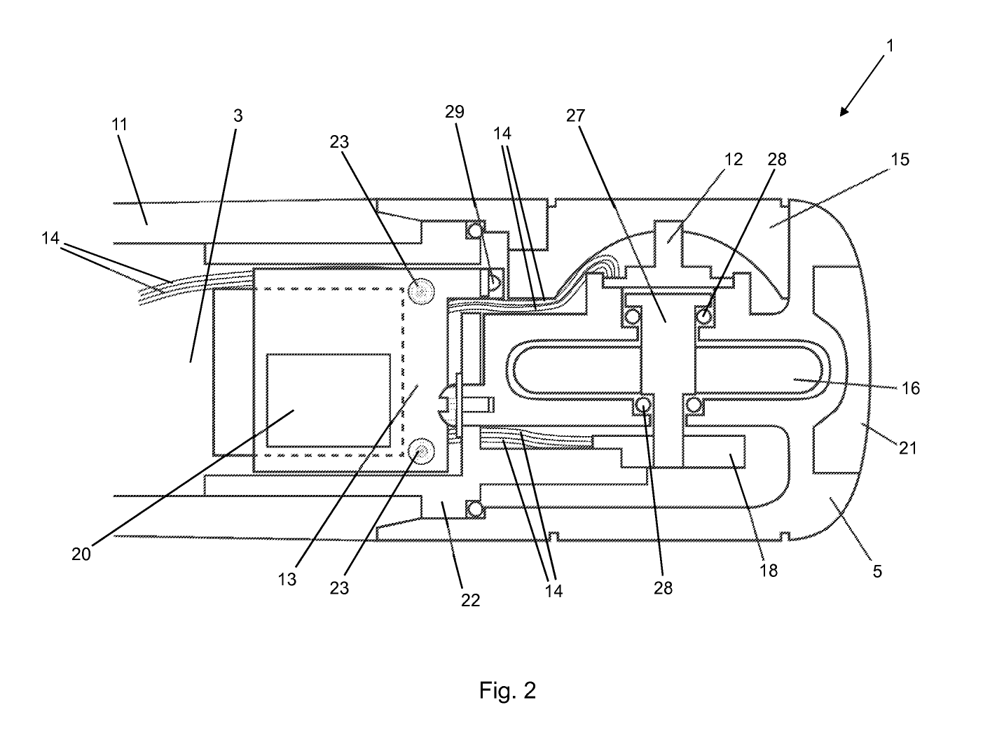

FIG. 2 shows a schematic, cross-sectional view of part of another embodiment of the vibrator according to the invention; and

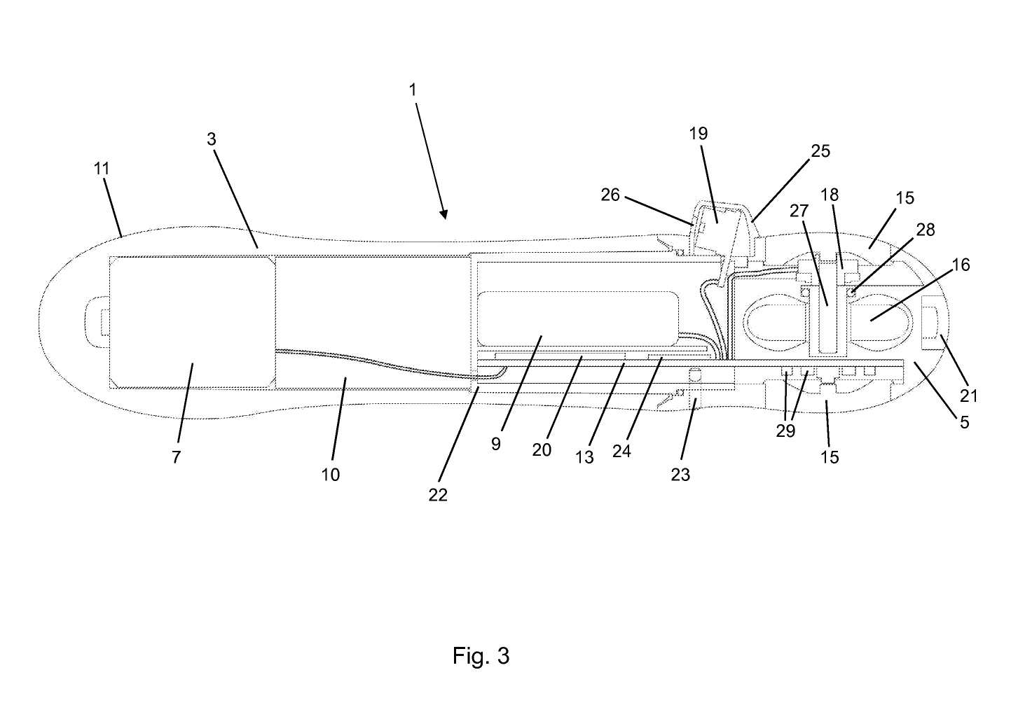

FIG. 3 shows a schematic diagram of another embodiment of the vibrator according to the invention.

FIG. 1 shows a schematic diagram of a preferred embodiment of a vibrator 1 according to the invention, wherein some of the elements are shown in a cross-section, others from above. The essentially cylindrical or rod-shaped vibrator 1 comprises a vibrator component 3 and an operating component 5 connected to the vibrator component; the two components come together or adjoin each other in the middle section of the vibrator 1. The vibrator component 3 is usually rounded at the front (on the left in FIG. 1) and comprises, on the inside, an electric motor 7 with a flywheel mass; the motor is arranged on the left in FIG. 1 and because of its unbalanced mass, it can operate as a vibration generator, causing the vibrator 1 to vibrate; the vibrator component also comprises an energy storage unit 9, arranged approximately in the middle of the vibrator. In the preferred embodiment, the energy storage unit 9 is configured as a lithium-ion battery, which offers a favorable price-performance ratio and is able to handle the somewhat greater power consumption of the wireless data communications device. Of course, other types of energy storage units can be used such as nickel-cadmium batteries, lithium-polymer storage batteries, or the like, which make it possible for the data communications function and camera element of the vibrator to operate over a total time of several hours. Between the electric motor 7 and the energy storage unit 9, a cavity filler 10 consisting of polyethylene foam is arranged. A silicone jacket 11, as normally used for these types of vibrators, surrounds the vibrator component. In the preferred exemplary embodiment shown, RTV (room-temperature vulcanization) silicone is used, which meets the special hygienic requirements and guidelines. The silicone jacket is configured to be smooth, but it could also comprise any of the usual features such as additional convexities, grooves, or corrugations.

The operating component 5, disposed on the right in FIG. 1, comprises a control unit 13 in the interior, at least one operating element 15, a housing 17, and a camera element 19. The operating component 5 is preferably made of a thermoplastic material such as acrylonitrile-butadiene-styrene copolymer (ABS). At the right end, the operating component 5 comprises an identification part 21, which contrasts by color, for example, from the color of the surface of the housing 17 and is preferably also formed of ABS. The identification part 21 is replaceable and can comprise the manufacturer's name, for example, or a logo. The control unit 13 is connected to the energy storage unit 9, the electric motor 7, and the camera element 19 by electrical lines 14. The electrical lines 14 can be configured as a ribbon cable, especially the connection between the camera element 19 and the control unit 13. Also electrically connected to the control unit 13 are two charging contacts 23 of corrosion-proof steel, which pass through a liquid-tight seal to the outside of the housing 17. The connection between the control unit 13 and the charging contacts 23 does not necessarily have to be direct, as shown in FIG. 1, but can also extend by way of flexible electrical lines.

Near the transition to the vibrator component 3, the lateral surface of the operating component 5 comprises a protrusion or projecting area 25, which is equipped with an optical passage or window 26, so that a field of view for the camera element 19 is created, which is oriented toward the forward end of the vibrator. The protrusion 25 is preferably made of ABS and fits into a recess in the housing 17; it forms a liquid-tight, essentially seamless transition to the surface of the housing 17. The protrusion 25 is configured as a replaceable insert, preferably together with the window 26 and the camera element 19. The material of the window or optical passage 26 is preferably PMMA, PC, or an equivalent material.

The camera element 19 comprises a standard commercial optical sensor or chip with high photosensitivity, such as that used in mobile telephones, for example. An optical or digital zoom function can be integrated into it. If desired, a light source, such as LEDs for taking pictures in complete darkness, can also be provided next to the optical sensor. Night-vision pictures with an infrared light source and an infrared sensor in the camera element 19 are also possible.

The control unit 13 comprises a main circuit board, on which the wireless data communications device (not shown in FIG. 1) is arranged. The wireless communications device in the preferred embodiment is a Bluetooth chip, which provides sufficient communications bandwidth for wirelessly transmitting images or videos in real time from the camera element 19 to a remote display unit. As an example of such a display, a mobile telephone with Bluetooth functionality can be mentioned. It is also possible for the images to be transmitted by the wireless data communications device to a remote computer (PC, laptop, tablet computer, or the like) or to an appropriately equipped television with a Bluetooth chip, the computer or television being connected to the Internet and capable of transmitting videos, for example, over an appropriately rated data line. The control unit 13 can comprise one or more data storage devices 24 for loader and function programs and for the (intermediate) storage of the data to be transmitted.

The operating element 15 comprises an operating insert of solid, translucent TPE (thermoplastic polymer), wherein a pressure-sensitive switch element or push-button element 12 is arranged underneath it, as will be described in detail with reference to FIG. 2. In this context, “translucence” is understood to mean that the operating component insert allows the light of the LEDs to shine through but prevents anything inside from being seen from the outside. With the operating element 15 configured as a push-button element 12, it is possible, for example, to control various function programs of the vibrator and to do this easily, because it can be operated with one hand by briefly exerting pressure with a finger. These function programs are preferably stored in the data storage device 24, and via the wireless data communications device 20 they can be activated externally by means of an application program (app) on a remote device such as a smartphone.

The energy storage unit 9 is charged by way of the charging contacts by the use of, for example, a charging cradle or charging attachment, which is connected to an appropriate adaptor (type A, 5V, 500 mAh) by a USB cable. The charging attachment is preferably held magnetically on the charging contact.

To ensure that the wireless data communications device can transmit data properly, without interference, electromagnetic shielding is provided around the electric motor 7 (not shown in FIG. 1). The energy storage unit 9 comprises overvoltage protection, which prevents the energy storage unit from being damaged by overcharging. Buffer elements of plastic foam or some similar type of material can also be arranged between the vibrator component 3 and the camera element 19 to isolate the latter from the vibrations.

FIG. 2 shows the end of the vibrator 1 comprising the operating component 5 according to another embodiment of the vibrator according to the invention. The cross-sectional view of FIG. 2 shows not only the elements already described with reference to FIG. 1 but also and in particular an additional operating element, which is configured as a rotary wheel 16. The advantage of the rotary wheel 16 is similar to that of the push-button element, namely, that it can be operated very easily with one hand or even with a single finger.

The rotary wheel 16, preferably made of ABS, comprises an axle 27, which is supported in the housing 17 of the operating component 5 by bearing elements 28. The axle 27 is connected to a potentiometer 18, which serves as a setting device and is electrically connected to the control unit 13 by lines 14. Other types of current or voltage controllers can be used, such as transistors or other sensors. By means of latching elements (not shown), the axle 27 of the rotary wheel 16 can be latched in certain positions, which correspond in turn to the corresponding functional positions of the vibrator 1. The control logic of the rotary wheel 16 is stored in, for example, a data storage component of the control unit 13. The support of the axle 27 of the rotary wheel 16 is sealed by O-rings, so that a liquid-tight seal satisfying the relevant standards is also obtained for the rotary wheel.

The operating element 15 with the push-button element 12 and operating component insert is arranged on the section of the axle 27 opposite the potentiometer 18. In FIG. 2, it can be seen that the push-button element 12 is also connected to the control unit 13 by lines 14. The push-button element 12 comprises a spring element and optionally a latching point; the resulting feedback makes it easier for the user to operate the button. An illuminating device 29, configured as an LED, which is preferably arranged in a space-saving manner on the main circuit board, uniformly illuminates the operating component insert of the operating element 15, which is made of translucent TPE. Additional LEDs can also be arranged inside the operating component 5 to illuminate the rotary wheel 16, for example, or other operating elements.

The wireless data communications device configured as a Bluetooth chip 20 is permanently connected to the main circuit board forming the control unit 13.

A frame element 22 serves to receive and to hold the essential components in the interior of the vibrator 1. Thus, for example, the silicone jacket 11 is adhesively bonded to it, and the control unit 13, the energy storage unit 9, and the potentiometer 18 are connected to it. The operating component 5 is sealed off against the frame element 22 by an O-ring and screwed to it.

The surfaces of the silicone jacket 11, of the operating component 5, and of the inserts and projecting areas merge essentially seamlessly with each other. The silicone jacket is seated positively on the operating component, possibly exerting slight pressure on it. So that the vibrator can meet the requirements on liquid-tightness according to protection type IP67 of DIN EN 60529 (dust-tight and protection against temporary submersion), the silicone jacket can also be bonded adhesively to the operating component.

It is understood that the arrangement and size of the individual components within the vibrator can be changed to save space to enable, for example, a compact configuration of the vibrator adapted to creating a so-called “mini-vibrator”.

Depending on the functional features of the vibrator, it is also possible for more than one pressure-sensitive switch element or push-button element to be arranged on the operating component; for example, push-buttons could be arranged 90° apart around the rotary wheel, wherein the various push-button elements could light up in different colors to indicate the different functional states.

A modified embodiment of this type is shown in FIG. 3. The essential structural difference versus the embodiment shown in FIG. 1 is that the control unit or main circuit board 13 is oriented in the longitudinal direction of the vibrator 1. It can also be seen in FIG. 3 that there is a data storage device 24 on the main circuit board 13; this storage device can serve to store programs and images or videos on a temporary basis. The protrusion 25 with the camera element 19 and the optical passage or window 26 is shaped somewhat differently than it is in the embodiment of FIG. 1.

With the subject matter according to the invention, a vibrator is provided which opens up novel possibilities for data communications exchange and interaction between client and service provider, and in particular the client acquires the ability to observe the use of the vibrator and to control its functions in real time.

1-9. (canceled)

10. A vibrator having a vibrator component and an operating component connected thereto, the vibrator comprising:
an electric motor serving to generate vibrations;
an energy storage unit;
a control unit having a wireless data communications device connected thereto and configured to transmit data; and
the operating component including (a) a housing, (b) a protrusion projecting in liquid-tight, seamless transition from the housing surface and having a camera window, (c) a camera element adjacent to the camera window, connected to the wireless data communications device which is configured to transmit data generated by the camera element to a remote display device, and (d) at least one operating element.

11. The vibrator of claim 10 wherein the functions of the vibrator are remotely controllable from a remote device by way of the wireless data communications device.

12. The vibrator of claim 10 wherein the operating element is configured as a rotary wheel integrated into the housing of the operating component.

13. The vibrator of claim 10 wherein the operating component comprises two corrosion-proof electrical charging contacts with a liquid-tight configuration on the outside surface of the housing.

14. The vibrator of claim 10 wherein the operating component comprises at least one display area which is adapted to displaying the functional state of the vibrator.

15. The vibrator of claim 14 wherein the display area is configured as a pressure-sensitive switch element.

16. The vibrator of claim 10 wherein the operating component comprises at least one light-emitting diode (LED).

17. The vibrator of claim 10 wherein the wireless communications device is configured as a Bluetooth or WLAN/Wi-Fi module.

18. The vibrator of claim 10 wherein the control unit and the wireless communications device are configured as an integrated unit.
